(19) United States
(12) Patent Application Publication
(10) Pub. No.: US 2007/0206481 A1
(43) Pub. Date: Sep. 6, 2007

(54) Optical scanning apparatus and method

(75) Inventors: Sjoerd Stallinga, Eindhoven (NL); Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,077

(22) PCT Filed: Mar. 11, 2005
(86) PCT No.: PCT/IB05/50884

§ 371 Date: Sep. 19, 2006

(30) Foreign Application Priority Data
Mar. 24, 2004 (EP) 04101212.1

(51) Int. Cl. G11B 7/00

(52) U.S. Cl. 369/112.23

(57) ABSTRACT

An optical scanning device which is compatible with both multi-layer and single layer disc formats, and which alleviates lens design requirements by providing a dual lens system and by making, say, lens OL0 compatible with DVD (as well as layer L0 of the dual layer format) and lens OL1 compatible with CD (as well as layer L1 of the dual layer format). Thus the two lens designs only need to work at two different wavelengths, and the device achieves compatibility with three different optical record carrier formats, but the amount of spherical aberration in respect of each lens part only needs to be matched precisely with respect to two formats in one of a number of known ways.

This invention relates to an optical element for an optical scanning device for reproducing, and optionally recording, optical record carriers of at least three different formats and with laser radiation of different respective wavelengths.

Optical data storage systems provide a means for storing great quantities of data on an optical record carrier, such as an optical disc. The data is accessed by focussing a laser beam onto the data layer of the disc and then detecting the reflected light beam. In one known system, data is permanently embedded as marks, such as pits, in the disc, and the data is detected as a change in reflectivity as the laser beam passes over the marks.

The optical disc storage technology that employs an optical disc with pit patterns as a high-density, large-capacity recording medium has been put into practical use while expanding its applications to digital versatile discs (DVDs), video discs, document file discs and data files.

In order to improve the recording density of an optical disc further, an increase in the numerical aperture (NA) of an objective lens has been studied recently. The objective lens focuses a light beam on the optical disc to form a diffraction-limited spot. However, spherical aberration, which is caused by an error in thickness of a base material for protecting a data record layer of the optical disc, increases strongly with NA. Thus, as optical storage discs increase in density and the NA of the objective lens becomes higher, the influence due to spherical aberration, arising when the cover layer of the disc deviates from the design value due to small variations in the manufacturing process of the disc or when dual layer discs are used, will increase accordingly, such that there will be distortion in the read-out signal.

In other words, for a high-NA readout system, compensation for spherical aberration is needed in order to increase the tolerances with respect to cover layer thickness variations or when dual layer discs are used, where spherical aberration is the phenomenon whereby the rays in a converging cone of light scanning the disc that make a small angle to the optical axis have a different focal point to that of the rays in the converging cone that make a large angle with the optical axis. This results in blurring of the spot and loss of fidelity in reading out the bit stream. The amount of spherical aberration that needs to be compensated for is proportional to the depth of the data layer it is focussed on, although a fixed amount of spherical aberration is compensated for by the objective lens producing the cone of light.

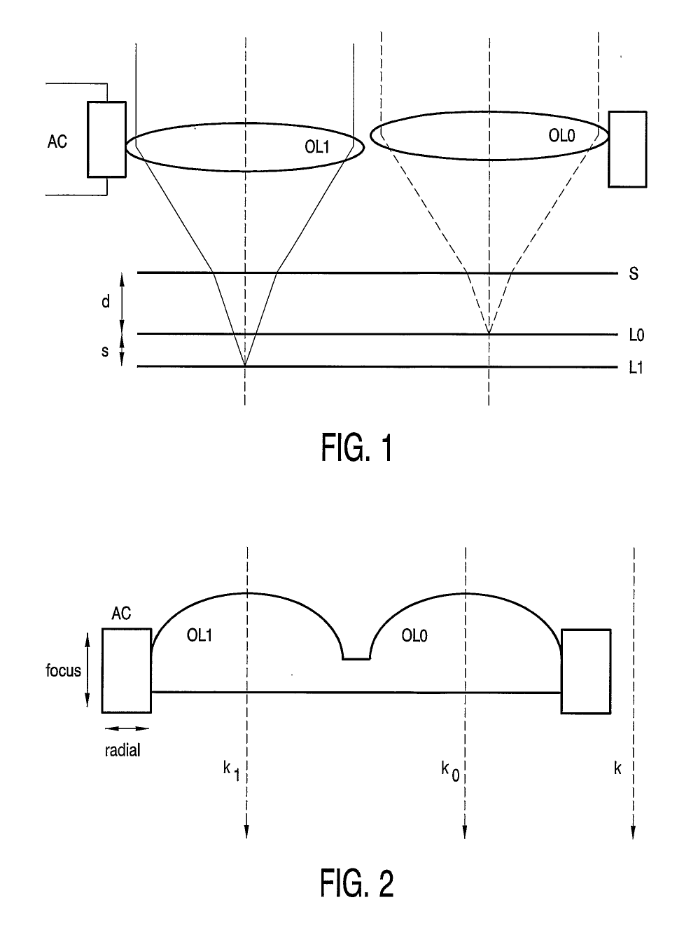

For portable applications, both the disc and the drive should be as small as possible. In order to achieve sufficient data capacity on a small disc, the use of a dual layer disc is quite favourable for this type of application. Referring to FIG. 1 of the drawings, in such a disc, the first data layer L0 is located at a depth d below the entrance surface S of the disc, the second layer L1 is located at a depth d+s. The top layer, of thickness d, is called the cover layer, and the intermediate layer, of thickness s, is called the spacer layer.

For discs having only a single layer, a fixed amount of spherical aberration can be compensated for by the objective lens producing the converging cone of light, but this is not sufficient for multi-layer discs. The latter type of disc needs compensation for the spherical aberration related to focusing through the spacer layer. This may be achieved by the use of two objective lenses, each of which compensates for spherical aberration in respect of layer L0 and L1 respectively. Thus, a typical optical scanning device, in this case, may comprise two objective lenses OL0 and OL1 for compensating for spherical aberration in respect of layer L0 and L1 respectively, the objective lenses being mounted in an actuator.

Referring to FIG. 2 of the drawings the two objective lenses OL0 and OL1 may be replaced by a monolithic component, manufactured by plastic injection moulding, where the mould contains the shape of two adjacent objective lens shapes OL0 and OL1 which are optimised for the read-out of layers L0 and L1 of a dual-layer disc. The assembly of the two lenses (FIG. 1) or the monolithic component with two lens shapes (FIG. 2) is mounted on the actuator AC, which is the part of the drive that can move in the radial and focus direction in order to keep the scanning spot on track and in focus.

A desirable property for an optical scanning device is compatibility, i.e. the ability to reproduce and (in some cases) record optical record carriers of different formats. Compact discs (CD's) are available, inter alia, as CD (CD-Audio), CD-ROMs (CD-Read Only Memory), CD-Rs (CD-Recordable) and CD-RWS (CD-Rewritable). CD's are designed to be scanned with laser radiation having a wavelength of around 780 nm and a numerical aperture (NA) of 0.45. DVD's (Digital Versatile Discs), on the other hand, are designed to be scanned at a wavelength in the region of 660 nm. In order to read DVDs, a NA of 0.6 is generally used, whereas for writing DVDs, a NA of 0.65 is generally required.

Nevertheless, DVD-drives are known which can also read out CD's. For example, WO99/57720 describes a system which is capable of reading DVD and CD by using laser radiation of different wavelengths with the same objective lens. The objective lens comprises a moulded plastic lens having either two refractive aspheric surfaces or one aspherical surface and one refractive spherical surface including a diffractive element. The lens is capable of correcting for spherical aberration caused by the difference in thickness for the two disc formats, as well as for chromatic aberration.

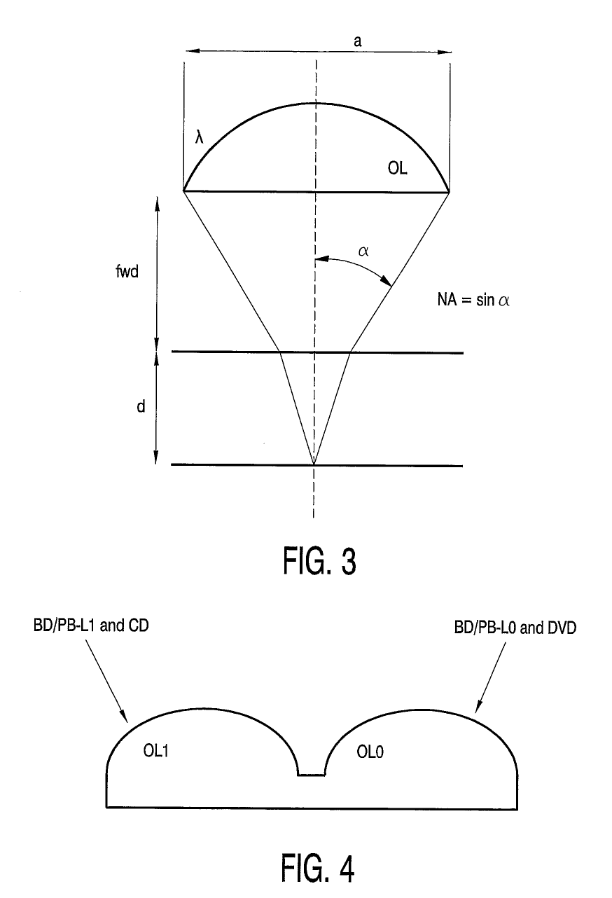

However, such known systems are not additionally compatible with multi-layer disc, such as dual-layer Blu-ray Disc (BD) or Portable Blue (PB), and it is obviously desirable to provide an optical scanning device which can not only read out dual layer BD/PB, but also DVD and CD. These three formats operate at the wavelengths 405 nm, 655 nm and 785 nm, at numerical aperture (NA) values of 0.85, 0.60-0.65 and 0.45-0.55, and with cover thicknesses of 70 and 100 :m (the two depths of the BD/PB system), 600 :m and 1200 :m, respectively. It follows, referring to FIG. 3 of the drawings, that the main parameters affecting lens design are different for the three formats. This puts rather severe requirements on the design of a triple compatible single lens. Moreover, a single lens needs additional spherical aberration compensation means in order to make dual (or multi) layer read-out possible.

It is therefore an object of the present invention to provide an improved optical scanning device which is compatible with multi-layer high-NA storage systems, such as the dual layer BD or PB, on the one hand, and discs of a different format, such as CD and DVD on the other hand.

In accordance with the present invention, there is provided an optical element for an optical scanning device for reading and/or writing an optical record carrier of any one of at least first, second and third formats, at least said first format comprising a multi-layer carrier format, said optical element comprising at least two objective lenses, a first of said objective lenses being arranged and configured to provide substantially optimal compensation for spherical aberration during reading and/or writing of both said second format and a first layer of said multi-layer carrier format, and a second of said objective lenses being arranged and configured to provide substantially optimal compensation for spherical aberration during reading and/or writing of both said third format and a second layer of said multi-layer carrier format.

Of course, it will be appreciated that each format requires electromagnetic radiation of different respective wavelengths for reading or writing and, in fact, a multi-layer format will generally require a different wavelength for each layer.

The objective lenses may comprise separate elements, but are more preferably provided in a monolithic, multi-lens component, manufactured by means of, for example, a plastic injection moulding technique. In fact, the present invention extends to a method of manufacturing an optical element as defined above, preferably by means of a plastic injection moulding technique.

The present invention extends still further to an optical scanning device for reading and/or writing to an optical record carrier of any one of at least three formats, the device comprising a source of electromagnetic radiation and including an optical element as defined above, whereby one of said objective lenses is used to focus a beam of electromagnetic radiation on a data record layer in accordance with the format of the optical record carrier being read and/or written, and an actuator for moving said optical element relative to said optical record carrier so as to maintain said electromagnetic beam focussed on said data record layer.

In one embodiment, the multi-layer optical record carrier format may comprise a first dual layer format, such as Blu-ray Disc (BD) or Portable Blue (PB) for example, whereas the second and third formats may, for example, comprise discs of a different format, such as single layer and/or single or dual layer CD DVD, respectively.

Each objective lens is preferably provided with a phase structure such as a diffractive structure or a non-periodic phase structure, and a refractive element. For example, each objective lens may be provided with a diffraction grating, more preferably a blazed grating, wherein the height of each blaze is selected such that for the various formats, high efficiency is achieved; beneficially at a single diffraction order. The blaze height for each respective format is preferably determined by h=λ/(n−1), where h is the blaze height, n is the refractive index of the medium (of which the objective lens is formed) and λ is the wavelength of the light of the particular readout mode.

These and other aspects of the present invention will be apparent from, and elucidated with reference to, the embodiment described herein.

An embodiment of the present invention will now be described by way of example only and with reference to the accompanying drawings, in which:

FIG. 1 is a schematic diagram illustrating an optical scanning device according to the prior art for dual layer read-out with a dual lens;

FIG. 2 is a schematic diagram illustrating a monolithic dual lens for use in an optical scanning device according to the prior art for dual layer read-out;

FIG. 3 is a schematic diagram illustrating the main parameters in lens design, whereby λ=wavelength, NA=numerical aperture, d=cover thickness, fwd=free working distance, and a=pupil diameter;

FIG. 4 is a schematic diagram illustrating a monolithic dual lens component for use in an optical scanning device according to an exemplary embodiment of the present invention, the dual lens component having lens parts OL0 and OL1, whereby lens part OL1 is compatible for read-out of layer L1 of a PB/BD system and for DVD, whereas lens part OL0 is compatible for read-out of layer L0 of the PB/BD system and for CD; and

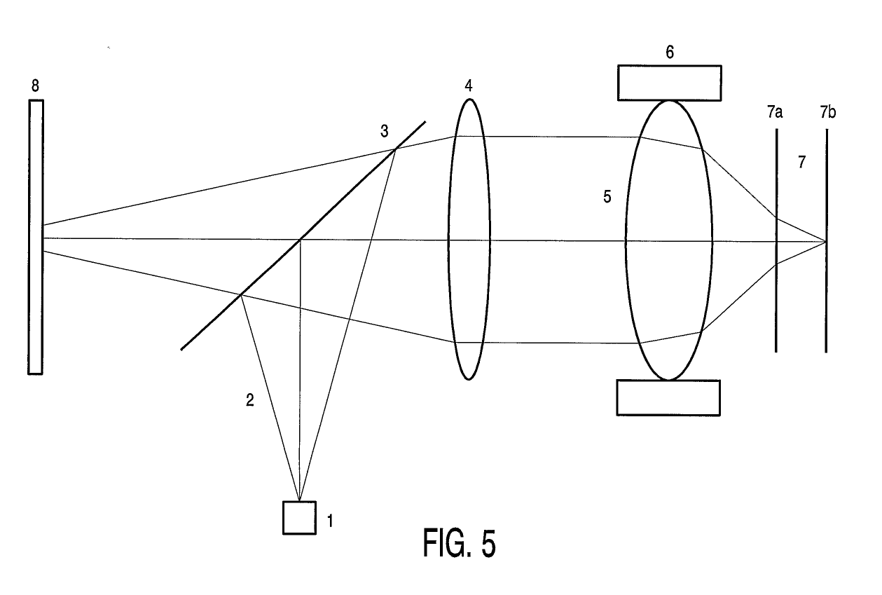

FIG. 5 is a schematic diagram illustrating the principal components of an optical recording system according to the prior art.

Thus, as explained above, the present invention provides an optical scanning device which is compatible with both multi-layer and single layer disc formats, and which alleviates lens design requirements by making use of a dual lens system such as that described above, for example, in respect of the dual layer BD/PB read-out, by making, say, lens OL0 compatible with DVD (as well as layer L0 of the dual layer BD/PD format) and lens OL1 compatible with CD (as well as layer L1 of the dual layer BD/PD format), as illustrated schematically in FIG. 4 of the drawings. Thus, the two lens designs only need to work at two different wavelengths, which simplifies matters considerably.

It will be appreciated by a person skilled in the art that there are a number of techniques which can be used to make a single lens compatible with two different disc formats. One way to achieve the desired compatibility is to employ a grating, for example, as described in WO02/41303. This document describes an optical scanning device which is capable of writing data to optical record carriers of a first format (e.g. DVD's) with high efficiency, because it is corrected for chromatic aberration resulting from fast wavelength variations during write operations, and it is capable of writing data to optical record carriers of a second format (e.g. CD's) at an acceptable efficiency. This is achieved by means of an objective lens comprising a diffractive element carrying a diffraction grating preferably of a sawtooth-like blazed grating structure, thereby providing a hybrid lens which combines diffractive and refractive elements, in an infinite-conjugate mode. The diffractive and refractive properties of the objective lens are selected such that radiation of a first wavelength compatible with optical record carriers of a first thickness (i.e format) is transmitted and focussed on an optical record carrier of said first format, and radiation of a second wavelength compatible with optical record carriers of a second thickness (i.e. format) is transmitted and focussed on an optical record carrier of said second format, with a relatively low level of spherochromatism. The diffractive and refractive properties of the objective lens are selected such that diffractive orders m1 and m2 of wavelengths λ₁ and λ₂ are used to scan optical record carriers of the first and second format respectively.

Referring back to FIG. 4 and this exemplary embodiment of the present invention, each of the lens parts L0 and L1 may be provided with a diffraction grating, preferably based on a blazed grating (with a similar concept to that described in WO02/41303), the height of each blaze being chosen such that for the various read-out wavelengths, high efficiency is achieved at a single diffraction order. By proper design of the grating, the different amounts of spherical aberration generated in different read-out modes can be used to compensate the spherical aberration arising due to the thickness in cover layer thickness. The problem, therefore, is to find the proper blaze heights to achieve high efficiency in one particular diffraction order for each read-out mode, as will now be explained in more detail.

Finding a blaze height suitable for CD/DVD/BD requires, when we define

$${h}_{CD} = \frac{{λ}_{CD}}{n - 1}$$

$${h}_{DVD} = \frac{{λ}_{DVD}}{n - 1}$$

$${h}_{BD} = \frac{{λ}_{BD}}{n - 1}$$

with n the refractive index of the medium and λ the wavelength in the particular readout mode, that
h≈m_{CD}h_{CD}≈m_{DVD}h_{DVD}≈m_{BD}h_{BD}
or similarly
m_{CD}λ_{CD}≈m_{DVD}λ_{DVD}≈m_{BD}λ_{BD}
where m are integer values. For CD and BD we find that
2m_{CD}=M_{BD}
and for DVD and BD we find
3m_{DVD}=2m_{BD}
The first solution is
m_{CD}=3
m_{DVD}=4
m_{BD}=6

A drawback of the high diffraction orders, especially for BD, is that the objective lens becomes sensitive to spherochromatism (i.e. the variation of spherical aberration with a change in wavelength). For this reason, lower diffraction orders are preferred. According to this exemplary embodiment of the present invention, for example, it is only necessary to combine CD/BD giving rise to m_{CD}=1 and m_{BD}=2 for lens OL0, and DVD/BD giving rise to m_{DVD}=2 and m_{BD}=3 for lens OL1. This gives rise to a more tolerant design.

Referring to FIG. 5 of the drawings, the light path of a conventional optical recording system comprises a radiation source 1, a beam of electromagnetic radiation emitted by the source 1, a beamsplitter 3, a collimator lens 4, an objective lens 5 mounted on an actuator 6 so that the lens can move in the focus and radial directions, a disc 7 with a front surface 7a and a rear surface 7b, and a detector 8. In accordance with the prior art, the data layer may be located at 7b and only a simple objective lens is used. In an optical recording system according to the invention, the single objective lens 5 may be replaced by the dual objective lens described above.

The present invention therefore achieves compatibility with three different optical record carrier formats, but the amount of spherical aberration in respect of each lens part only needs to be matched precisely with respect to two formats in one of a number of known ways (for example, as described in detail in WO02/41303), whereas if an attempt is made to match spherical aberration with respect to three formats, this cannot generally be achieved using prior art techniques with any precision, such that a compromise is required. In this case, therefore, a residual amount of spherical aberration must be accepted, which leads to a decrease in performance.

Although the example given herein is one in which the phase structure is composed of blazed grating, it may also, for example, be of the binary type as described in U.S. Pat. No. 6,687,037. The phase structure may also be of a non-periodic phase structure type such as that described in “Application of nonpriodic phase structures in optical systems”, by B. H. W. Hendriks, J. E. de Vries and H. P. Urback in Appl. Opt. Vol 40 (2001) p 6548.

An embodiment of the present invention has been described above by way of example only, and it will be apparent to a person skilled in the art that modifications and variations can be made to the described embodiment without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “ an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage. It will further be appreciated that the various disc formats referred to herein are examples only, and other disc formats whether single or multi-layer will be apparent to a person skilled in the art.

1. An optical element for an optical scanning device for reading and/or writing an optical record carrier of any one of at least first, second and third formats, at least said first format comprising a multi-layer carrier format, said optical element comprising at least two objective lenses, a first of said objective lenses being arranged and configured to provide substantially optimal compensation for spherical aberration during reading and/or writing of both said second format and a first layer of said multi-layer carrier format, and a second of said objective lenses being arranged and configured to provide substantially optimal compensation for spherical aberration during reading and/or writing of both said third format and a second layer of said multi-layer carrier format.

2. An optical element according to claim 1, wherein the objective lenses comprise separate elements.

3. An optical element according to claim 1, wherein the objective lenses are provided in a monolithic, multi-lens component.

4. An optical element according to claim 3, wherein said monolithic component is manufactured by means of a plastic injection moulding technique.

5. An optical element according to claim 1, wherein each objective lens is provided with a diffractive and a refractive element.

6. An optical element according to claim 5, wherein each objective lens is provided with a diffraction grating.

7. An optical element according to claim 6, wherein said diffraction grating is a blazed grating, wherein the height of each blaze is selected such that for the various formats high efficiency is achieved at a single diffraction order.

8. An optical element according to claim 7, wherein the blaze height for each respective format is determined by h=λ/(n−1), where h is the blaze height, n is the refractive index of the medium (of which the objective lens is formed).

9. A method of manufacturing an optical element according to claim 1.

10. A method according to claim 9, comprising a plastic injection moulding process.

11. An optical scanning device for reading and/or writing to an optical record carrier of any one of at least three formats, the device comprising a source of electromagnetic radiation and including an optical element according to any one of claims 1 to 8, whereby one of said objective lenses is used to focus a beam of electromagnetic radiation on a data record layer in accordance with the format of the optical record carrier being read and/or written, and an actuator for moving said optical element relative to said optical record carrier so as to maintain said electromagnetic beam focussed on said data record layer.

12. An optical scanning device according to claim 1, wherein said multi layer format comprises Blu-ray Disc or Portable Blue.

13. An optical scanning device according to claim 12, wherein said second and third formats may comprise CD and DVD respectively.
